(19) United States
(12) Patent Application Publication
(10) Pub. No.: US 2006/0224537 A1
(43) Pub. Date: Oct. 5, 2006

(54) Device for optimizing diagnostic trees of a diagnostic tool of a communication network

(75) Inventors: Arnaud Gonguet, Paris (FR); Gerard Delegue, Cachan (FR); Stephane Betge-Brezetz, Paris (FR); Julien Robinson, Paris (FR); Lionel Fournigault, Gif Sur Yvette (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/372,128

(22) Filed: Mar. 10, 2006

(30) Foreign Application Priority Data
Mar. 11, 2005 (FR) 0550641

(51) Int. Cl. G06F 15/18

(52) U.S. Cl. 706/16

(57) ABSTRACT

A device is dedicated to optimizing diagnostic trees for a communication network including a diagnostic tool adapted to analyze operating and/or configuration data of the network by means of diagnostic trees constituted of nodes each associated with a set of (at least one) network tests and interconnected by branches representing logical relations between tests so as to deliver diagnostic reports describing causes of problem(s) in the network. The device comprises first storage means adapted to store at least certain of the reports delivered by the diagnostic tool and processing means adapted firstly to analyze the contents of stored reports corresponding to at least one selected diagnostic tree to determine information representing usage trend(s) of nodes and/or branches of the selected diagnostic tree and secondly to compare the information to rules describing behavior problems of at least portion(s) of diagnostic trees as a function of usage trends of node(s) and/or branch(es) of the diagnostic trees, so as to determine behavior problems of the selected diagnostic tree.

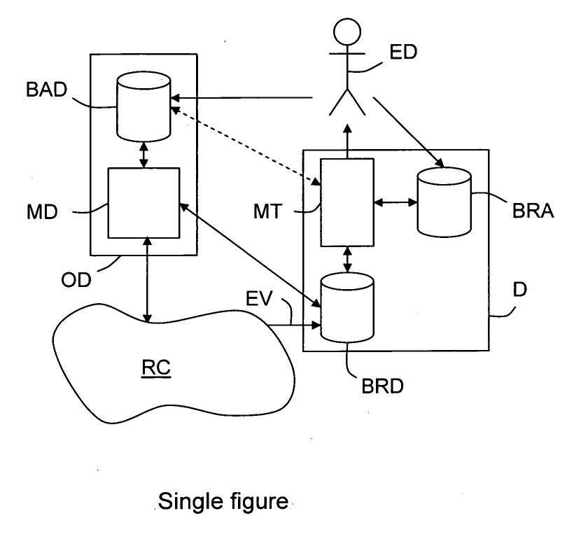

### CROSS-REFERENCE TO RELATED APPLICATIONS

This application is based on French Patent Application No. 05 50 641 filed Nov. 3, 2005, the disclosure of which is hereby incorporated by reference thereto in its entirety, and the priority of which is hereby claimed under 35 U.S.C. § 119.

### BACKGROUND OF THE INVENTION

1. Field of the invention

The invention relates to the field of communication networks and more precisely to optimizing the operation of such networks.

2. Description of the Prior Art

As the person skilled in the art is aware, diagnostic tools have been created for determining the causes of problems occurring in communication networks, such as reduced quality of service (QoS), for example.

Certain of those diagnostic tools use diagnostic trees to determine the causes of problems. A diagnostic tree is a structure constituted of nodes each associated with one or more network tests and interconnected by branches representing logical relations between tests known as causality relations. The leaves (or terminations) of a diagnostic tree correspond to particular causes of problems (causes explaining the origin of a problem), the father nodes of those leaves correspond to the causes of those particular causes, and so on until the root node of the tree is reached that corresponds to a root cause corresponding to the root problem to be explained.

For example, if the diagnostic tool is dedicated to quality of service, it has diagnostic trees each associated with one type of quality of service problem.

To determine each particular cause that is the origin (root) of a problem, the diagnostic tree that corresponds to the problem is scanned from its root node to one or more of its leaf nodes. The results of the tests defined at each node of the scan are deemed to make it possible to determine each cause of a problem precisely, in order to be able to remedy it effectively.

Because of the great complexity of networks, diagnostic trees are generally very complex and designing them is particularly difficult. Because of this, the diagnostic trees are rarely the optimum, even on their first use in a network. The experts who design diagnostic trees must therefore optimize them regularly in order to improve their accuracy and thereby enable more appropriate corrective action.

To effect such optimizations, the experts must analyze the contents of diagnostic reports supplied by their diagnostic tools in the light of their knowledge of the operation of the network and compare the results of those analyses to the actual causes of problems. What is more, because the experts do not know which portion of a diagnostic tree they have to optimize, they are obliged to consider all of the branches of the diagnostic tree.

Thus optimization is based entirely on the analyses effected by the experts, who may not have available all of the diagnostics arrived at, and therefore all of their results, and/or may have misinterpreted the very large amount of information available. Moreover, a diagnostic tree can be optimized only at the initiative of an expert. Also, optimization may be time consuming in that an expert does not know, a priori, which tree portion(s) to adapt.

There is another type of diagnostic tool based on the use of Bayesian networks. A Bayesian network is a causality tree constituted of branches (or links) respectively associated with complementary probabilities and having nodes designating basic (or elementary) tests to be effected.

Bayesian networks can certainly be optimized automatically by modifying the complementary probabilities associated with the various links as a function of validated results. However, it cannot be used to modify the structure of a causality tree, for example by adding or removing one or more nodes.

Thus an object of the invention is to improve upon the situation whereby no known solution is entirely satisfactory in the case of diagnostic trees.

### SUMMARY OF THE INVENTION

To this end, the invention proposes a device for optimizing diagnostic trees for a communication network including a diagnostic tool adapted to analyze operating and/or configuration data of the network by means of diagnostic trees so as to deliver diagnostic reports describing causes of problem(s) in the network.

The device comprises:
first storage means adapted to store at least certain of the reports delivered by the diagnostic tool, and
processing means adapted firstly to analyze the contents of stored reports corresponding to at least one selected diagnostic tree to determine information representing usage trend(s) of nodes and/or branches of the selected diagnostic tree and secondly to compare the information to rules describing behavior problems of at least portion(s) of diagnostic trees as a function of usage trends of node(s) and/or branch(es) of the diagnostic trees, so as to determine behavior problems of the selected diagnostic tree.

The device of the invention may have other features and in particular, separately or in combination:
its rules may be of “condition/action” type;
its processing means may be adapted to generate messages describing the behavior problems of an analyzed diagnostic tree;
the behavior problems may be selected, for example, from a group comprising at least one given node that is never used, given nodes that are never used, a given node that always has the same state, given nodes that systematically have the same state, and at least one root cause that is always detected;
its processing means may be adapted to determine at least one proposal for modification of a diagnostic tree taking account of its behavior problems;
the processing means may be adapted, for example, to modify a diagnostic tree as a function of a modification proposal relating to it;
the processing means may be adapted, for example, to integrate the diagnostic tree modification proposals into the messages;
the diagnostic tree modification proposals may be selected from a group comprising a need to eliminate at least one given node, a need to group given nodes, excessive selectivity of a logical relation between given nodes, and insufficient selectivity of a logical relation between given nodes;
second storage means adapted to store the rules;
its rules may relate, for example, to diagnostic trees of cause(s) of service problems (for example quality of service, or QoS) or infrastructure problems (for example connectivity between cells of a GSM network (management of handover—transfer between cells)).

The invention is particularly well adapted, although not exclusively so, to mobile (or cellular) communication networks, such as GSM, GPRS/EDGE and UMTS networks, for example, and to wireless local area networks, for example of the WiMAX type.

### BRIEF DESCRIPTION OF THE DRAWING

Other features and advantages of the invention will become apparent on reading the following detailed description and examining the appended drawing, the single FIGURE whereof shows in highly schematic form one example of a device of the invention for optimizing diagnostic trees, coupled to a diagnostic tool. The appended drawing constitutes part of the description of the invention as well as contributing to the definition of the invention, if necessary.

### DETAILED DESCRIPTION OF THE PREFERRED EMBODIMENT

An object of the invention is to provide for automated determination of optimizations to diagnostic trees used by a diagnostic tool for determining the causes of problems occurring in a communication network.

The communication network considered hereinafter by way of nonlimiting example, and the subject of the diagnoses, is a mobile network, such as a GSM, GPRS/EDGE or UMTS network, for example. However, the invention is not limited to that type of network. It relates to all types of communication network in which operating and/or configuration data may be diagnosed by means of diagnostic trees, and in particular to WiMAX type wireless local area networks.

The diagnostic tool considered hereinafter by way of nonlimiting example is dedicated to quality of service and therefore has diagnostic trees each associated with one type of quality of service (QoS) problem. However, the invention is not limited to that type of diagnostic alone. It relates to all types of diagnostics that may be effected within a network, and in particular to diagnostics relating to services (such as quality of service, for example) and diagnostics relating to the infrastructure of the network (such as connectivity between cells of a GSM network (management of handover —transfer between cells), for example).

The single FIGURE is a schematic showing a diagnostic tool OD. This kind of tool OD generally comprises a database BAD in which data defining diagnostic trees is stored.

As indicated in the introduction, a diagnostic tree comprises nodes each of which is associated with one or more network tests and which are interconnected (in accordance with a “father-son” dependency relation) by branches that represent logical relations between tests (known as causality relations). The tests analyze configuration and/or operating data of the network RC. The data may be aggregated for a network equipment or for a set of network equipments. The leaf nodes (or terminations) of a diagnostic tree correspond to different possible causes of a given (root) problem with the operation or configuration of the network RC. The father nodes of the leaf nodes correspond to the causes of their causes, and so on until the root node of the diagnostic tree is reached that corresponds to a root cause that expresses a given (root) problem.

The data defining the diagnostic trees is supplied to the database BAD by an expert ED.

The diagnostic tool OD also comprises a diagnostic module (or engine) MD for analyzing operating and/or configuration data that it receives from the network RC by means of diagnostic trees the data whereof is stored in the database BAD and delivering diagnostic reports that describe the causes of problem(s) occurring in the network RC.

The diagnostic tool OD is operative either at the level of the network management layers (NML) when it is dedicated to optimizing diagnostic trees of the network architecture or at the level of operation support system (OSS) layers when it is dedicated to optimizing service diagnostic trees.

The invention proposes a device D for optimizing diagnostic trees intended to determine automatically optimizations for the diagnostic trees the data whereof is stored in the database BAD of the diagnostic tool OD.

The device D is also operative at the level of the logic layers (NML or OSS) cited above. For example, it may be physically installed in the operation support system (OSS).

The diagnostic tree optimization device D includes first storage means BRD and a processor module MT.

The first storage means BRD store the contents of at least certain of the reports that are delivered by the diagnostic tool OD (and preferably all of the reports). Each report is stored in corresponding relationship to the diagnostic tree to which it relates, and preferably with timing information (for example a time stamp representing its sending time).

Here the first storage means BRD take the form of a database, for example, but they may take any form, such as the form of a simple storage memory, for example.

As shown in the single FIGURE, the first storage means BRD may where appropriate include an auxiliary input EV enabling the operator of the network RC to monitor the contents of the reports stored, for example to validate or invalidate them, in order for the device D to use only validated reports.

The processing module MT first analyzes the contents of at least certain of the reports that are stored in the first storage means BRD and that correspond to at least one designated diagnostic tree, designated by the expert ED, for example. The objective is to determine information representing usage trend(s) of one or more nodes and/or of one or more branches of the designated diagnostic tree by comparing the contents of a plurality of (at least two) reports that relate to it.

The analysis is preferably a statistical analysis. Consequently, the greater the number of reports compared the more reliable the analysis. Moreover, any mathematical method known to the person skilled in the art may be used to effect the analyses, and in particular methods using analysis rules or data mining.

An analysis may conduct a search for a plurality of correlation types. For example, a search to determine if one (or more) node(s) of a diagnostic tree is (are) never used, a search to determine if one (or more) node(s) of a diagnostic tree always has (have) the same state (“true” or “false”) or a search to determine if at least one root cause is always detected. The above examples are not limiting on the invention. A search may be conducted for any type of correlation relating to the diagnostic tree nodes used and/or to the diagnostic tree branches scanned.

When the analysis is a statistical analysis, each analysis result is associated with a percentage (or a probability) of occurrence.

For example, an analysis result may indicate that in 90% of cases node X is used (or is not used). For example, another analysis result may indicate that in 80% of cases nodes W, X, Y and Z are in their “true” state. A further analysis result may indicate, for example, that in 60% of cases branches 1, 2, 5 and 12 are always used together. A further analysis result may indicate, for example, that in 100% of cases the same root cause is always detected.

It is important to note that an analysis does not necessarily bear on the reports of only one diagnostic tree. It may bear on the reports of a plurality of (at least two) diagnostic trees if the latter have interconnected nodes.

Each time that the processing module MT has effected an analysis, it compares the information provided by that analysis to rules that describe behavior problems of at least portion(s) of diagnostic trees as a function of node usage trends and/or diagnostic tree branch(es).

This comparison is intended to determine behavior problems of the diagnostic tree that is being analyzed for which solutions (or optimizations) exist.

The rules are designed by the expert ED and supplied to the device D which stores the data that defines them, for example in second storage means BRA, as shown in the single FIGURE.

Like the first storage means BRD, the second storage means BRA can take the form of a database, but may take any form, such as the form of a simple storage memory, for example. The first storage means BRD and the second storage means BRA may equally constitute two portions of a single storage means, such as an optimization database.

The rules are preferably of “condition/action” type, that is to say “if a condition is satisfied (or fulfilled) then an action is effected”. Thus each rule defines an appropriate behavior of a portion of one or more diagnostic trees. In the present context, the term “portion” refers to one or more nodes and/or one or more branches of a diagnostic tree. As a general rule, the rules bear on the branches of the trees rather than on one or more branches of only one tree.

For example, if nodes are never used, that may mean that branches or causality links are too selective. If nodes that are used always simultaneously have a “true” state, this may mean that they may be eliminated or grouped together. If nodes that are used always simultaneously have a “false” state, this may mean that they may be grouped together or that branches or causality links are insufficiently selective. If root causes are systematically detected, this may mean that branches or causality links are insufficiently selective.

The analyses effected preferably being statistical analyses, the rules therefore include a statistical (or probabilistic) condition. One such rule takes the following form, for example: “if two root causes are found at the same time in 50% of cases, then the anterior node at which the branches diverge includes tests that are insufficiently selective” or “if a root cause is found at the same time in 70% of cases, then the anterior node at which the branch diverges includes tests that are insufficiently selective”.

By comparing the analysis result to the rules, the processing module MT can detect any behavior problem listed in said rules. It can then generate a message describing each behavior problem that it has detected in a given diagnostic tree, to enable the expert to solve it.

However, the processing module MT may equally determine one or more propositions for modification of a diagnostic tree taking account of behavior problems that it has detected therein. It suffices for it to take each rule defining a detected behavior problem to extract the corresponding action therefrom, and then to associate the portion of the tree giving rise to the problem with that action. For example, if the nodes W, X, Y and Z are simultaneously in their “true” state in 80% of cases, then the processing module MT may propose grouping them into a single node or to make the test of the convergence node more selective.

As a general rule, the proposals for modifying (or optimizing) a diagnostic tree may specify, for example, that one or more given nodes should be eliminated, or that a plurality of nodes should be grouped together, or that a logical relation between given nodes is too selective, or that a logical relation between given nodes is insufficiently selective.

The processing module MT may also have specific complementary rules enabling it to determine each proposal for modifying (and thereby optimizing) a diagnostic tree.

If the processing module MT is responsible for determining proposals for modifying (and thereby optimizing) diagnostic trees of the tool D, it may be adopted to integrate its proposals for modifications into a message addressed to the expert ED. It may also be envisaged, where appropriate, that the processing module MT modify the diagnostic tree concerned directly (in the diagnostic tool OD) as a function of the proposed modifications that it has determined for it.

The diagnostic tree optimization device D of the invention, and in particular its processing module MT and where applicable its first and second storage means BRD, BRA, may take the form of electronic circuits, software (or electronic data processing) modules or a combination of circuits and software.

Moreover, the diagnostic tree optimization device D of the invention may form part of a diagnostic tool OD.

The invention is not limited to the diagnostic tree optimization device embodiments described above by way of example only, and encompasses all variants that the person skilled in the art might envisage that fall within the scope of the following claims.

1. A device for optimizing diagnostic trees for a communication network including a diagnostic tool adapted to analyze operating and/or configuration data of said network by means of diagnostic trees constituted of nodes each associated with a set of (at least one) network tests and interconnected by branches representing logical relations between tests so as to deliver diagnostic reports describing causes of problem(s) in said network, which device comprises first storage means adapted to store at least certain of said reports delivered by said diagnostic tool and processing means adapted firstly to analyze the contents of stored reports corresponding to at least one selected diagnostic tree to determine information representing usage trend(s) of nodes and/or branches of said selected diagnostic tree and secondly to compare said information to rules describing behavior problems of at least portion(s) of diagnostic trees as a function of usage trends of node(s) and/or branch(es) of said diagnostic trees, so as to determine behavior problems of said selected diagnostic tree.

2. The device according to claim 1, wherein said rules are of “condition/action” type.

3. The device according to claim 1, wherein said processing means are adapted to generate messages describing said behavior problems of an analyzed diagnostic tree.

4. The device according to claim 1, wherein said behavior problems are selected in a group comprising at least one given node that is never used, given nodes that are never used, a given node that always has the same state, given nodes that systematically have the same state, and at least one root cause that is always detected.

5. The device according to claim 1, wherein said processing means are adapted to determine at least one proposal for modification of a diagnostic tree taking account of its behavior problems.

6. The device according to claim 5, wherein said processing means are adapted to modify a diagnostic tree as a function of a modification proposal relating to it.

7. The device according to claim 5 wherein said processing means are adapted to generate messages describing said behavior problems of an analyzed diagnostic tree, and further wherein said processing means are adapted to integrate said diagnostic tree modification proposals into said messages.

8. The device according to claim 5, wherein said diagnostic tree modification proposals are selected from a group comprising a need to eliminate at least one given node, a need to group given nodes, excessive selectivity of a logical relation between given nodes, and insufficient selectivity of a logical relation between given nodes.

9. The device according to claim 1, comprising second storage means adapted to store said rules.

10. The device according to claim 1, wherein said rules relate to diagnostic trees of cause(s) of problems selected from a group comprising service problems and infrastructure problems.
